(19) United States
(12) Patent Application Publication
(10) Pub. No.: US 2009/0289936 A1
(43) Pub. Date: Nov. 26, 2009

(54) PORTABLE ELECTRONIC LOYALTY DEVICES

(75) Inventors: Paul Daniel Sheedy, Essex (GB); Harkamaljit Has Dosanjh, Surrey (GB)

Correspondence Address: POLSINELLI SHUGHART PC, 700 W. 47TH STREET, SUITE 1000, KANSAS CITY, MO, 64112-1802, US

(73) Assignee: REWARD TECHNOLOGY LIMITED, London (GB)

(21) Appl. No.: 12/441,653

(22) PCT Filed: Sep. 18, 2007
(86) PCT No.: PCT/GB2007/050556

§ 371 Date: Mar. 17, 2009

(30) Foreign Application Priority Data
Sep. 18, 2006 (GB) 0618266.1

(51) Int. Cl. G09G 5/00; H04Q 5/22

(52) U.S. Cl. 345/214; 345/59; 340/10.1

(57) ABSTRACT

A mobile device for use in processing a transaction, comprises an electronic card, tag, fob or similar small portable device having a stored identity and comprising a housing having vertical and horizontal dimensions of a standard credit card, a tag, a fob or the like, transmitter/receiver means including an RFID transmitter and configured to communicate with a local computer for receiving messages, processor means for receiving, storing and outputting messages, and an output device configured to reproduce messages in visible or audible form. The aforesaid card, tag, fob or similar small portable device may be used in association with apparatus for reading and processing the card, tag, fob or similar small portable device consequent on a transaction involving a user of said card, tag, fob or similar small portable device, said apparatus comprising a reader for electronic remote reading of the stored identity on a card, tag, fob or similar small portable device, a processing station for processing a transaction involving the holder of the card, tag, fob or similar small portable device, a local computer configured to receive the identity read by the reader and transaction information from the processing station, and to cause a message to be transmitted to the card, tag, fob or similar small portable device, and one or more remote computers configured to contain a database of identities and transactions for the cards, tags, fobs or similar small portable devices and to generate messages for storage on the cards, tags, fobs or similar small portable devices, the local computer being configured to alert said remote computer or one of said remote computers on reading of a stored identity, and to supply information for use at said local computer concerning one or more messages to be transmitted to and stored on said card, tag, fob or similar small portable device.

### FIELD OF THE INVENTION

This invention relates to an electronic card, fob or similar small portable device, to apparatus for handling communications initiated by an electronic card, fob or similar small portable device and to apparatus for processing a transaction. In an embodiment, an advanced loyalty card, fob or similar small portable device is provided for retailers, which card, fob or similar small portable device allows for communication to customers on offers/points/information sent to the card, fob or similar small portable device.

### BACKGROUND TO THE INVENTION

Loyalty cards are used by retailers for a number of reasons. These include the ability for the retailer to gain insight into customer's behavioural patterns, to offer incentives such as money back offers or points to redeem, and to use the data collected to achieve more targeted marketing to customers.

Most loyalty cards are credit card type devices with a magnetic strip identification on the back. These cards usually have an identification number on the front. They may also take the form of identification tags that have a bar code printed on them and which are scanned at the till to identify the customer. Other cards contain microchips like in chip and pin credit cards or RFID chips.

Use of loyalty cards is widespread within the retail sector especially with retailers that have regular repeat visits such as supermarkets. These loyalty cards with their ability to specifically identify individual customers have allowed retailers to assess ways to segment their customers into specific groups based on their purchasing habits. The transactional data collected can be managed to produce marketing strategies to build loyalty by sending specific offers to customers in these categories. Offers can be sent by post as coupons or printed on receipt tape for example. The cards can also work to build up points that can be redeemed in various ways. By giving points for spending at a particular retailer or a group of retailers the idea is that a customer builds a greater loyalty to that brand and is rewarded with offers or points to redeem.

Cards or tags used by retailers up to now are simply for identification purposes to reward the customer with points or offers. The identification also allows them to hold data on the individual for marketing and/or planning purposes. The cards are therefore a passive element in the marketing ability for the retailers.

US Patent Publication 2003/0167207 (Berardi et al) discloses that companies are increasingly embodying RFID data acquisition technology in a fob or tag for use in completing financial transactions. A typical fob includes a transponder and is ordinarily a self-contained device which may be contained on any portable form factor. In some instances, a battery may be included with the fob to power the transponder, in which case the internal circuitry of the fob (including the transponder) may draw its operating power from the battery power source. Alternatively, the fob may exist independent of an internal power source, in which case the internal circuitry of the fob (including the transponder) may gain its operating power directly from an RF interrogation signal. In the Berardi et al system, a transponder-reader payment system includes a fob including a transponder, and a RFID reader for interrogating the transponder. The system may further include a payment device separate and distinct from the fob, but associated with payment account mutually shared with the fob. In exemplary operation, the fob identifying information, or the payment device information, may be presented to the RFID reader for completion of a transaction request. A process server may receive the transaction request and satisfy the transaction request in accordance with predetermined payment criteria. The process server may additionally augment a rewards account based on fob or payment device usage, thereby incentivising fob usage in one instance and payment device usage in the other.

A particular area in which the invention is useful is the targeting of promotions to customers. At present, although in-store loyalty cards are used to group customers according to their purchasing habits and to permit tailored offers to be made to particular customers (see e.g. U.S. Pat. No. 5,956,693 which describes customer behavioural segmentation), these offers e.g. promotional coupons are customarily sent by mail. Customers often forget to bring the coupons with them when they re-visit the store, and the uptake of even tailored promotions is low e.g. as little as 2%. Furthermore, promotion by post as is currently the norm is expensive. One solution disclosed in U.S. Pat. No. 6,292,786 (Deaton et al., Incentech Inc) is to make offers available to customers at the point of sale before they leave the store e.g. using a printer located at the point of sale, the in-store system also providing for coupon validation and the sending of e-mails to customers. Incentives may be in the form of redeemable coupons. Another solution discussed in US-A-2007/0162337 (Hawkins et al) is the use of a so-called “loyalty kiosk.” A further solution is proposed in recently published US-A-2007/0198334 (Mebruer) in which customers are identified by a RFID tag and targeted offers are sent by a SMS message to a mobile phone. However, this requires the customer to carry two electronic devices.

### SUMMARY OF THE INVENTION

In one aspect the invention provides an electronic card, tag, fob or similar small portable device comprising:

a housing having vertical and horizontal dimensions of a standard credit card, tag, fob or similar small portable device or the like,

transmitter/receiver means including an RFID transmitter for transmitting a stored identity and configured to communicate with a remote computer for receiving messages;

processor means for receiving, storing and displaying messages; and

at least one flat panel display visible at least one face of the card, tag, fob or similar small portable device and configured to display received messages.

In another aspect, the invention provides an electronic card, tag, fob or similar small portable device comprising:

a housing preferably having vertical and horizontal dimensions of a standard credit card, tag, fob or similar small portable device or the like,

transmitter/receiver means including an RFID transmitter and configured to communicate with a remote computer for receiving messages;

processor means for receiving, storing and outputting messages; and

an output device configured to reproduce messages in visible or audible form.

In a further aspect, the invention provides apparatus for handling transactions initiated by an electronic card, tag, fob or similar small portable device having at least one stored identity, comprising:

a reader for electronic remote reading of a stored identity on a card, tag, fob or similar small portable device;

a processing station for processing a transaction involving a holder of the card, tag, fob or similar small portable device;

a local computer configured to receive an identity read by the reader and transaction information from the processing station, and to cause a message to be transmitted to the card, tag, fob or similar small portable device; and

one or more remote computers configured to contain a database of identities and transactions for the card, tag, fob or similar small portable devices and to generate messages for storage on the card, tag, fob or similar small portable device,

the local computer being configured to alert said remote computer or one of said remote computers on reading of a stored identity, and to supply information for use at said local computer concerning one or more messages to be transmitted to and stored on said card, tag, fob or similar small portable device.

In a yet further aspect, the invention provides apparatus for processing a transaction, comprising:

an electronic card, tag, fob or similar small portable device having a stored identity and comprising a housing having vertical and horizontal dimensions of a standard credit card, tag, fob or similar small portable device or the like, transmitter/receiver means including an RFID transmitter and configured to communicate with a local computer for receiving messages, processor means for receiving, storing and outputting messages, and an output device configured to reproduce messages in visible or audible form; and

apparatus for reading and processing a card, tag, fob or similar small portable device consequent on a transaction involving a user of said card, tag, fob or similar small portable device, said apparatus comprising a reader for electronic remote reading of the stored identity on a card, tag, fob or similar small portable device, a processing station for processing a transaction involving the holder of the card, tag, fob or similar small portable device, a local computer configured to receive the identity read by the reader and transaction information from the processing station, and to cause a message to be transmitted to the card, tag, fob or similar small portable device, and one or more remote computers configured to contain a database of identities and transactions for the card, tag, fob or similar small portable devices and to generate messages for storage on the card, tag, fob or similar small portable device, the local computer being configured to alert said remote computer or one of said remote computers on reading of a stored identity, and to supply information for use at said local computer concerning one or more messages to be transmitted to and stored on said card, tag, fob or similar small portable device.

The apparatus described above offers a store or supermarket the possibility of providing electronic loyalty devices in the nature of cards, fobs or the like which not only enable the identity of a customer to be read electronically as he or she enters the store or supermarket, but using a compiled database specific to the customer or to a group to which the customer belongs, transmit specific offers to the customer and display the offers on a display forming part of the card, fob or the like. Furthermore, the customer device carries his or her identity electronically and/or recorded on a bar code, magnetic strip or identity chip forming part of the device, so that at time of check out the correct offer price for selected items is made available to the customer. The invention provides these possibilities in a single customer-held device which both electronically announces the customer identity on arrival and can receive offers through an in-store system.

### BRIEF DESCRIPTION OF THE DRAWINGS

How the invention may be put into effect will now be described, by way of example only, with reference to the accompanying drawings, in which:

FIG. 1 is a view from the front of a mobile device in the form of a loyalty card for relatively long-range communication with an in-store access point and for relatively short range communication with a point-of-sale device;

FIG. 2 is an exploded view of the card of FIG. 1;

FIG. 3 is a diagrammatic flowchart showing how the mobile device of FIGS. 1 and 2 may be used in a supermarket forming part of a chain of such supermarkets having a central computer for controlling data received from and sent to the mobile devices; and

FIG. 4 is a view of two mobile devices in the form of fobs displaying different messages.

### DETAILED DESCRIPTION OF PREFERRED EMBODIMENTS

In embodiments of the invention, the presently proposed advanced card, tag, fob or similar small portable device has a number of features that already exist in normal cards or similar articles. They will have identification which will be through an RFID chip. The difference however is that the card, tag, fob or similar small portable device has the ability to do two distinct functions, it can communicate with RFID readers and writers to identify itself and receive data from RFID writers at the store, it can also alert/display/communicate offers or information on the card, tag, fob or similar small portable device for the customer to read. Therefore one of its principal advantages is that it becomes the means to communicate between the retailer and the customer. The card, tag, fob or similar small portable device may become an integral part of a process that will work in the following way.
(a) The customer is identified when he or she first enters the store.
(b) The store's computer that holds data on the customer is alerted that this customer is in the store and that pre-designated offers should be made accessible for delivery soon.
(c) The customer makes his or her purchases which are scanned at the till and identifies themselves with their loyalty card, tag, fob or similar small portable device.
(d) The transactional data is sent to the store's computer that can then decide to change or carry on with sending the customer their original list of offers.
(e) The customer's card, tag, fob or similar small portable device, once identified again by the next RFID reader/writer will be sent the data containing the offers/points/information.
(f) The customer can then be communicated to by the card, tag, fob or similar small portable device either by reading from a screen or listening from a sound device in the card, tag, fob or similar small portable device about what offers/points/information they have received.
(g) On the next visit to the store the card, tag, fob or similar small portable device will alert the store's computer that a customer with offers has entered the store and that on completion of all products being scanned at the till should be ready to adjust the bill to reflect the offers/points/information made available.

The following are considered advantageous:

1. In some embodiments a loyalty card, tag, fob or similar small portable device is provided which allows a retailer to remotely identify specific customers entering a store.
2. In embodiments of the invention, a loyalty card, tag, fob or similar small portable device is provided that can hold both identification information on the customer and variable data specifically for the customer, e.g. relating to their offers/points/information.
3. In embodiments of the invention, the loyalty card, tag, fob or similar small portable device allows the customer to access what offers/points/information he or she has gained from the purchases made at the store.
4. In embodiments of the invention, a loyalty card, tag, fob or similar small portable device can be communicated to and identify itself to devices in a store for the purpose of communicating offers.
5. Embodiments of the card or other customer-carried mobile device can identify itself to the reader, have data sent to it, hold data and communicate this data to the customer in one device.

Principal components of the mobile device (card, tag, fob or similar small portable device), in some embodiments include:

(a) A RFID identification chip to identity the specific card, tag, fob or similar small portable device by the reader
(b) A RFID aerial to facilitate transfer of information
(c) A memory chip to hold data on offers/information
(d) A devise to transfer that data into a communicative form
(e) A device to communicate the offers
(f) A housing for the components
(g) A power supply
(h) Optional additional identification i.e. barcode or print identification

The mobile user communications devices may be in the form of cards that employ a standard form factor provided by ISO 7810. For example, its length and width may be about 85.60×53.98 mm (3.370×2.125 in) with corners rounded with radius of 3.18 mm and thickness preferably 0.76 mm or above (e.g. about 4-5 mm), corresponding to the length and width of existing plastics bank cards of ID-1 size. It may alternatively be of ID-2 size (105×74 mm) or A7 form factor corresponding to the dimensions of a German identity document (Personalausweis). The mobile user communications device may be of alternative configuration, for example that of a key tag or fob or another device of cylindrical or polygonal (e.g. square or rectangular) shape or a shape resembling that of a tag for a hotel room key for an older-type mechanical lock.

Embodiments of the mobile devices have a first mode of communication via an access point with an in-store processor using wireless local area network technology (WLAN) usually running at 2.4 GHz or 5 GHz in accordance with IEEE 802.11, IEEE 802.11a, IEEE 802.11b, IEEE 802.11g or IEEE 802.15 (Bluetooth). They communicate with an in-store access point connected to a local server for a supermarket or like installation. This mode of communication is relatively long range and is inexpensive to implement, but in some embodiments of the invention, only to provide a signal via the access point to the in-store processor that a mobile device having an identity stored within that device is present within range of the access point e.g. has entered the supermarket. In other words, the function of the WLAN part of the mobile device and the access point is to up-load the stored identity only.

Embodiments of the mobile devices communicate with a transaction processing station such as a supermarket checkout as a proximity card (see e.g. ISO 14443 and in particular ISO 18092:2004). That standard defines communication modes for near field communication (NFC) interface and protocol (NFCIP-1) using inductive coupled devices operating at a centre frequency of 13.56 MHz for interconnection of computer peripherals and at present allows for data exchange at a rate of up to 424 kbit/s. It also defines both the Active and the Passive communication modes of NFCIP-1 to realize a communication network using NFC devices for networked products and also for consumer equipment. What makes the communication between the devices so easy is that the NFC protocol provides some features not found in other general-purpose protocols. It is a very short-range protocol and supports communication at distances measured in centimeters. The devices have to be literally almost touched to establish the link between them. This has two important consequences:

(a) The devices can rely on the protocol to be inherently secure since the devices must be placed very close to each other. It is easy to control whether the two devices communicate by simply placing them next to each other or keeping them apart.

(b) The procedure of establishing the protocol is inherently familiar to people: you want something to communicate—touch it. This allows for the establishment of the network connection between the devices be completely automatic and to happen in a transparent manner. The whole process feels then like if devices recognize each other by touch and connect to each other once touched. Another important feature of this protocol is the support for the passive mode of communication. This is very important for battery-powered devices since they have to place conservation of energy as the first priority. The protocol allows such a device, like a mobile phone, to operate in a power-saving mode of battery operated NFC communication. This mode does not require both devices to generate the RF field and allows the complete communication to be powered from one side only. Of course, the device itself will still need to be powered internally but it does not have to “waste” the battery on powering the RF communication interface. It will be appreciated that the protocols identified herein are those frequently in use at the time of writing, but further technical developments are likely to give rise to additional communication protocols, the use of which is also contemplated.

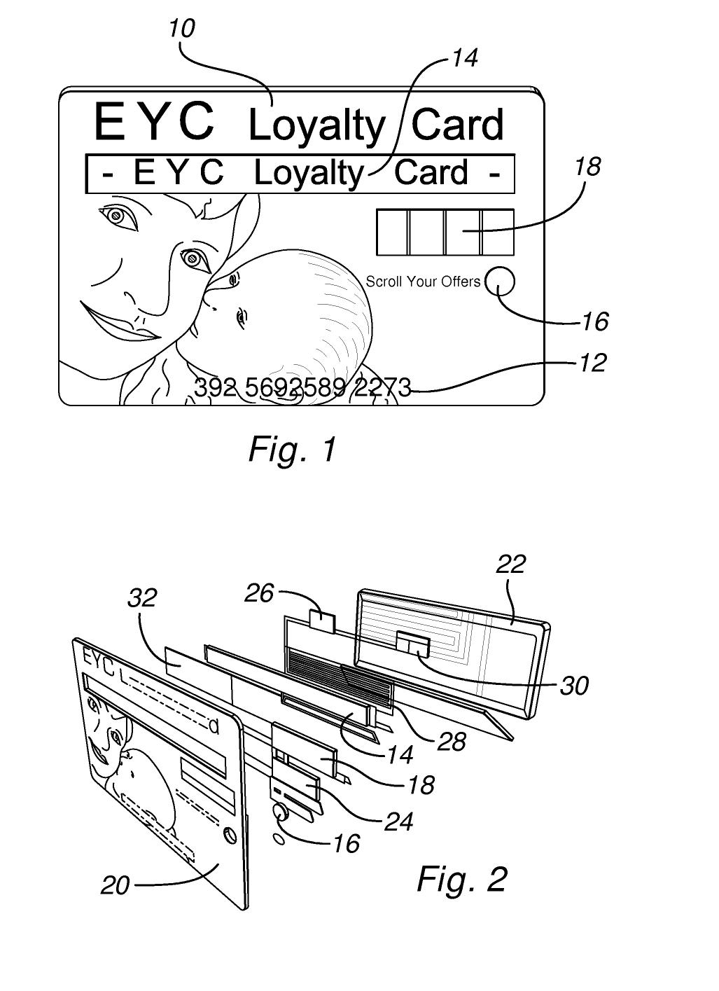

In FIG. 1, a loyalty card 10 which forms a mobile device is of ID-1 form factor but slightly increased thickness and comprises on its front face a legible user identification number 12, a display 14 in the form of an LCD or LED strip for displaying moving messages, a scroll button 16 for scrolling through messages stored in the card 10 and an optional solar cell 18. The display 14 is typically in the form of a scanned dot-matrix array of LED or LCD pixels that produce a running display by shifting the displayed characters by one column for each scan of the array, the characters being fetched from a memory sequentially and decoded into dot matrix form, see e.g. U.S. Pat. No. 4,024,531 (Ashby; National Research Development Corporation), U.S. Pat. No. 4,205,312 (Nelson, Computer Kinetics Corporation) and U.S. Pat. No. 4,358,761 (Iwasaki, Sanyo electric Co. Ltd) the disclosures of which are incorporated herein by reference. The display may be single-line and may conveniently display characters of height of 5 or 7 pixels, e.g. for displaying an alphanumeric character set in 5×5 or 7×5 dot matrix format, using e.g. a pixel array in 8×8 pixel sub-blocks which are easy to drive as character matrices using 8-bit technology. The display may be configured to show at least a minimum number of characters for easy moving message comprehension e.g. at least 8 characters, possibly 10-40 characters in the line, more possibly about 28 characters which is convenient for displaying stored communication messages of e.g. up to 60 characters. This message length enables a plurality of messages to be stored e.g. up to 10 stored messages per retail organization each of length about 60 characters. Alternatively a multi-line display may be incorporated. The rear face of the card may have a space for a user signature, a repeat of the identification number, and a barcode storing the identification number. It will be appreciated that more complex displays e.g. black and white or colour screens supporting both characters and graphics may be used, in which case there will be greater freedom of display format.

A simplified internal structure of the card is shown in FIG. 2. It comprises a housing front 20 and a housing rear 22 between which fit inter alia the display 14, scroll button 16 and optional solar cell 18 together with battery 24, RFID chip 26, RFID antenna 28, processor and communications chip 30 for controlling a display or sound device and cover 32 for protecting the display 14.

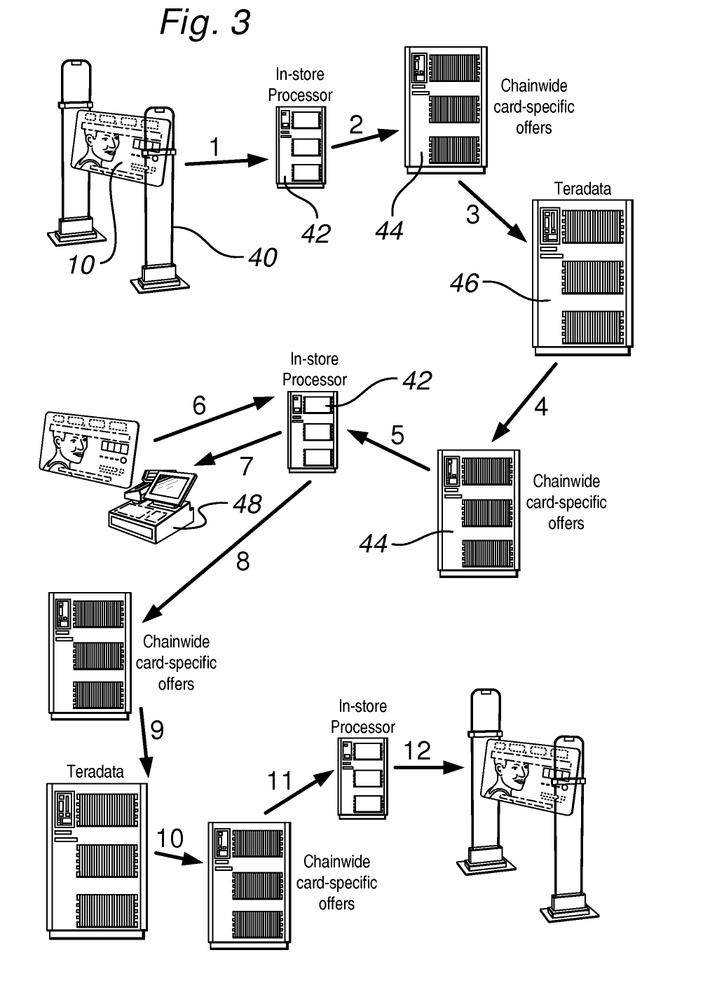

Use of the card in a supermarket, being one of a chain of such supermarkets is diagrammatically illustrated in FIG. 3. At step 1, as a user enters the supermarket, card 10 may be energised by the field of a standard e.g. 8.2 MHz electronic alarm sensor 40 or other appropriate energizing device to energize RFID component of the card 10 and cause it to transmit the user's identity to in-store processor 42. At steps 2 and 3, the in-store processor alerts computer 44 running a centralized customer relations management program to adjust the billing on offers that the user has already been given on his or her card and prepare a centralized database computer 46 to download a new list of offers to go on the card 10. At step 3 the centralized database computer 46 contacts the customer relations computer 44 to download the user's offers and alert to be prepared for new offer download. At step 5 the customer relationship computer 44 informs the in-store computer 42 of these offers and that the customer will be coming to a payment station 48 soon. The user may have his or her goods scanned at the payment station and their RFID card or barcode recorded on the device scanned. This may be done remotely or it may be via a bar code optically and/or magnetically recorded on the card or incorporated in a chip on the card that is directly readable. At step 7, the identifier is sent to the in-store computer 42 and the till receipt is adjusted to allow for offers to be taken off the bill. At step 8 the in-store computer 42 now informs customer relations computer 44 of purchases just completed and to adjust pre-agreed offers as maybe required. The customer relations computer 44 sends information (step 9) to central database computer 46 to confirm new offers for the user, the central database computer 46 sends new offers to the customer management computer 44 (step 10) and these offers are sent to the in-store computer (step 11). The in-store computer alerts exit RFID writer to send the offers once the card has been identified at the exit (step 12).

Various modifications may be made to the embodiment described above without departing from the invention. For example, if the card has a single RFID device or similar identity/communications device (e.g. a LFC chip for longer range communications) which also allows for bidirectional communication, then instead of update at the point of sale, the messages in the card could be updated as the customer leaves the supermarket. The offers may be re-communicated to the customer using his card, fob or other personal device for display on the built-in display thereof as the customer re-enters the store. A further possibility is that a number of different organizations may support the loyalty cards described herein and may have computer systems and detector/communications devices configured to do so. For example if a customer carrying a card as described above enters a first location of a first organization, he or she may be asked by a question on the display whether he or she wishes to be come a loyalty customer of the first organization, or they may be automatically allocated as a loyalty customer of the first organization. An affirmative decision (where called for) may be indicated by operation of the scroll button or the like, after which the identity of the card and data for the card is loaded into the computer system of the first organization, The same sequence of steps may be carried out when the user take the card into premises of a second or subsequent organization. Data about customers may be stored locally in individual stores and, and the segmentation and analysis of customers and the computation of offers to be made electronically to them may be carried out in-store (i.e. after step 2 in FIG. 3 the system proceeds direct to steps 6, 7 and then to steps 12, 13).

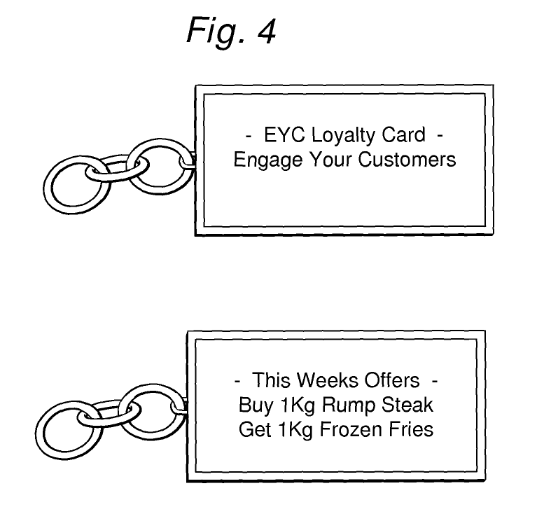

A further embodiment (FIG. 4) is a key fob e.g. with dimensions of the order of 6 cm×2.5 cm×1 cm which can be used to display as well as store customer information. It is envisioned that as soon as a customer enters the store, the fob will transmit the customer's ID to the store's computer system via a wireless link. The store can then transmit any pertinent information to the customer such as special offers or updated customer reward information. In order to realise such a device, the fob may contain a Liquid Crystal Display (LCD) to display the pertinent information, active Radio Frequency Identification (RFID) components, an antenna in which to create a communication link between the key fob and the store, and means in which to power the device such as a battery. It is also expected that the key fob will have a functional lifetime of several years.

Two frequency bands ˜13 MHz (also known as High Frequency (HF)) and ˜900 MHz (also known as Ultra High Frequency (UHF) are both well recognised frequency bands for RFID technology. One of the major differences between these two frequency bands is their reach. The reach is the maximum distance the key fob can be from the store's wireless transmitter/receiver and still communicate. The ˜13 MHz band components typically have a reach of approximately one and a half meters whereas the ˜900 MHz band have a reach of approximately three meters. Reach is important as it is unlikely that a customer will stop and wait for data to be transferred to and from his or her key fob. Hence the wireless connection needs to be maintained long enough for the fob to transmit the customer's ID to the store's computer, the store's computer to access the customer's file, the store to transmit the customer's data to the fob, all by the time the customer is within the reach of the store's transmitter/receiver. In order to minimize the risk of a customer passing through the communication region without completing the necessary data transfer, the ˜900 MHz band is preferred. Frequencies in the USA are 902-928 MHz and in Europe are 865-868 MHz. The communication reach of the 2.4 GHz band (which is also a preferred option) is of the order of tens of metres and so a single store transmitter/receiver could be used to communicate with all customers in the store at this frequency, but components working at this frequency are presently more costly and there are issues of interference from other devices.

The principal electrical components of the fob comprise:

(a) An RF antenna for converting wireless electromagnetic signals into electrical signals for use by the electronic components of the fob and for transmission back to the store. Such antennas are available. For example, Fractus SA produces an RF antenna FR05-S1-R-0-105 which is a surface mount device easily attachable to a PCB containing the rest of the fob circuitry and having a small form factor (1.8 cm×0.73 cm×0.1 cm) which allows it to fit inside the fob casing. Alternatively, a standard dipole antenna may be sufficient and has the advantage that it can be integrated into a PCB, thereby reducing the number of discrete components required to build the fob.
(b) A transceiver for receiving electrical signals from the RF antenna and for converting them into a useable electronic data stream for passing to a microcontroller. The transceiver is also responsible for coding data sent to it by the microcontroller into an electrical signal for subsequent wireless transmission by way of the RF antenna.
(c) A microcontroller for analyzing the data stream passed to it by the transceiver and responding it in accordance with stored instructions e.g. to store incoming data into memory, write data to the screen, or to pass contents of the memory to the transceiver for transmission to the store e.g. to permit the store to identify a customer. Combined transceivers and microcontrollers are also known and are advantageous for reducing component inventory as well as minimizing the problems associated with multiple high frequency components on a PCB e.g. the Chipcon CC1010 (Texas Instruments) integrated transceiver and microcontroller which measures 1.2 cm×1.2 cm×0.12 cm, thus fitting comfortably inside the key fob dimensions. This component has 32 kb of internal memory which could be used to store the identity of the customer. As a typical alphanumeric character is defined in binary code by 8 bits, the memory could conceivably store approximately 4000 characters by which to convey information to the customer. It can also be put into a power down mode which would be advantageous for power conservation purposes. A similar microcontroller is available from Zensys (ZM3102N)
(d) An LCD controller/driver for receiving a data stream passed to it by the microcontroller, converting it into characters and symbols and placing them on the display. The controller driver also controls the powering of the display. A suitable output capacity for the display for the key fob is 3 lines, with 20 characters per line. Generally speaking the screen provider provides or incorporates the required screen controller
(e) A display. Suitable displays currently available include Trident Technologies MDLS 20433-LV which is a monochrome LCD with four lines of 20 characters per line and Densitron LM4434 which is similar and has dimensions of 9.9 cm×6.0 cm×1.3 cm.
(f) A power supply for the circuit, which may be a disposable battery hardwired to the circuit. The maximum output wireless power that a transceiver will typically be required to generate is about 10 mW in case there are issues with the absorption of the human body. The customer may be identified by an 18 digit number, such as those found on existing loyalty cards. At a data transfer rate of 0.6 kbps and a transceiver transmit current of 26.2 mA (for 10 mW wireless power), the fob will use 1.8×10⁻³ mAh for each instance it has to transmit data from the fob to the store. Assuming that two transmissions will be required from the fob for each shopping experience (one when the customer enters the store and the second when the customer is at the checkout) and that a customer shops once a day for 365 days, the current capacity needed to make these transmissions annually is approximately 1.3 mAh. A typical LCD screen requires approximately 3 mA of current while data is being written to it or while data is on the screen. Assuming that a customer will view the screen (e.g. upon the press of a button to wake up the fob) six times during his or her shopping experience for 10 seconds each time, this action will draw approximately 0.05 mAh. Assuming the customer shops every day for 365 days per year, the screen will require a current capacity of approximately 18 mAh per annum. If the LCD uses a backlight then this will significantly add to the current consumption. The microcontroller will require approximately 26 mAh per annum when powered up, and 2 mAh per year when powered down, so that a total power requirement may be about 50 mAh per year which is within the capacity of disposable batteries. For preservation of the battery, one solution is to use energy in the antenna when it is being energized by the wireless signal sent from the store to turn on the key fob so that it could communicate with the store. However, a better and lower cost solution is to provide a button or other control that the user can operate when he or she enters the store to wake up the fob.
(g) Optionally a bar-code printed and/or magnetically recorded on the fob or recorded in a readable chip therein so that the customer identity is made available at the point of sale in the same way as a conventional loyalty card.

The above components may be used in association with a store transmitter/receiver (sometimes referred to as a reader) for transmit data to and for receiving data from a customer's key fob. It typically contains a powered RF antenna and transceiver as well as other components necessary to allow for simultaneous communication with multiple key fobs. The transmitter/receiver is then connected to the store's computer system where the customer's data is stored along with software needed for communication between the store ad the customer's key fob.

It will be appreciated that at least some of the above components may be used mutatis mutandis for the card embodiment.

What is claimed is:

1. An electronic card, tag, fob or similar small portable device comprising:
a housing having vertical and horizontal dimensions of a standard credit card or for a tag, fob or the like;
transmitter/receiver means including an RFID transmitter for transmitting a stored identity and configured to communicate with a remote computer for receiving messages;
processor means for receiving, storing and displaying messages; and
a flat panel display visible at one face of the card, tag, fob or similar small portable device and configured to display received messages or other output device configured to reproduce messages in visible or audible form.

2. The card, tag, fob or similar small portable device of claim 1, having an RFID means operating at a first frequency for longer distance of communication, and the transmitter/receiver means being operable at a second frequency when adjacent a communications point.

3. The card, tag, fob or similar small portable device of claim 2, which having a memory means configured to store a first identity for RFID transmission and a second identity for communication when adjacent the access point.

4. The card, tag, fob or similar small portable device of claim 1, wherein the display is a strip display for displaying moving messages.

5. The card, tag, fob or similar small portable device of claim 4, wherein the strip display is configured to display dot matrix characters.

6. The card, tag, fob or similar small portable device of claim 4, wherein the display is a single-line display.

7. The card, tag, fob or similar small portable device of claim 1, further comprising a user input device signalling the card, tag, fob or similar small portable device to scroll between stored messages.

8. (canceled)

9. Apparatus for handling transactions initiated by an electronic card, tag, fob or similar small portable device having at least one stored identity, comprising:
a reader for electronic remote reading of a stored identity on a card, tag, fob or similar small portable device;
a processing station for processing a transaction involving a holder of the card, tag, fob or similar small portable device;
a local computer configured to receive an identity read by the reader and transaction information from the processing station, and to cause a message to be transmitted to the card, tag, fob or similar small portable device; and
one or more remote computers configured to contain a database of identities and transactions for the card, tag, fob or similar small portable device and to generate messages for storage on the card, tag, fob or similar small portable device, the local computer being configured to alert said remote computer or one of said remote computers on reading of a stored identity, and to supply information for use at said local computer concerning one or more messages to be transmitted to and stored on said card, tag, fob or similar small portable device.

10. The apparatus of claim 9, wherein said reader is configured to energize the RFID means of said card, tag, fob or similar small portable device.

11. The apparatus of claim 9, wherein said sensor comprises a pair of spaced loops and a means for supplying RF to at least one of said loops.

12. The apparatus of claim 9, wherein the processing apparatus comprises a transceiver station configured to operate at a frequency other than that of the reader.

13. The apparatus of claim 9, wherein said remote computers comprise first a computer means configured to execute a user relations management program and a second computer means configured to execute a user database program.

14. Apparatus for processing a transaction, comprising:
electronic card, tag, fob or similar small portable device having a stored identity and comprising a housing having vertical and horizontal dimensions of a standard credit card or the like, a transmitter/receiver means including an RFID transmitter and configured to communicate with a local computer for receiving messages, a processor means for receiving, storing and outputting messages, and an output device configured to reproduce messages in visible or audible form; and
an apparatus for reading and processing the card, tag, fob or similar small portable device consequent on a transaction involving a user of said card, tag, fob or similar small portable device, said apparatus comprising a reader for electronic remote reading of the stored identity on the card, tag, fob or similar small portable device, a processing station for processing a transaction involving the holder of the card, tag, fob or similar small portable device, a local computer configured to receive the identity read by the reader and transaction information from the processing station, and to cause a message to be transmitted to the card, tag, fob or similar small portable device, and one or more remote computers configured to contain a database of identities and transactions for the card, tag, fob or similar small portable device and to generate messages for storage on the card, tag, fob or similar small portable device, the local computer being configured to alert said remote computer or one of said remote computers on reading of a stored identity, and to supply information for use at said local computer concerning one or more messages to be transmitted to and stored on said card, tag, fob or similar small portable device.

15. The apparatus of claim 14, wherein said output device is a flat panel display.

16. The apparatus of claim 14, wherein the local computer is located in a supermarket, and said one or more remote computers are remote form said supermarket and connected to said local computer through a network.

17. The apparatus of claim 14, wherein said card, tag, fob or similar small portable device is a loyalty card.
